(19) United States
(12) Patent Application Publication
(10) Pub. No.: US 2014/0350840 A1
(43) Pub. Date: Nov. 27, 2014

(54) CROWD PROXIMITY DEVICE

(71) Applicant: Cellco Partnership d/b/a Verizon Wireless, Basking Ridge, NJ (US)

(72) Inventors: Michael J. D'ARGENIO, Green Brook, NJ (US); Kristopher T. FRAZIER, McKinney, TX (US); Lonnie KATAI, Murphy, TX (US)

(73) Assignee: Cellco Partnership d/b/a Verizon Wireless, Basking Ridge, NJ (US)

(21) Appl. No.: 13/901,178

(22) Filed: May 23, 2013

(51) Int. Cl. G01S 19/03

(52) U.S. Cl. CPC G01S 19/03
USPC 701/409

(57) ABSTRACT

A device is configured to determine that a first user device and a second user device are associated with an event and determine a first user device location indicating a location of the first user device and a second user device location indicating a location of the second user device. The device is configured to determine a relationship between the first user device location and the second user device location and determine first event information and second event information based on the relationship, where the first event information and the second event information is associated with the event, and the first event information is different from the second event information. The device is configured to provide the first event information to the first user device and provide the second event information to the second user device.

### BACKGROUND

Users of user devices (e.g., cellular telephones, computing devices, etc.) may be members of a crowd associated with an event (e.g., a concert, a sporting game, etc.). The user devices may be capable of receiving and/or transmitting information associated with the event.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for providing event information to user devices based on a proximity of the user devices to one another;

FIGS. 5A and 5B are diagrams of an example implementation relating to the example process shown in FIG. 4;

FIGS. 6A-6C are diagrams of another example implementation relating to the example process shown in FIG. 4; and

FIG. 7 is a diagram of yet another example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

A user of a user device (e.g., a cellular telephone, a computing device, etc.) may be associated with an event (e.g., a concert, a sporting game, etc.). The user may desire to interact with other users associated with the event via the user device. For example, the user may desire to join the user device with other user devices associated with the other users to display event information (e.g., videos, pictures, animations, etc.) on the user devices in a collective manner. The collective manner may include a manner that allows the user devices to display different types and/or portions of event information based on respective locations of the user devices. However, the user devices may not be able to interact due to the fact that the users are unknown to each other. Implementations described herein may allow user devices to interact in a collective manner to display information associated with an event based on the participation of the user devices in the event and the proximity of the user devices to one another.

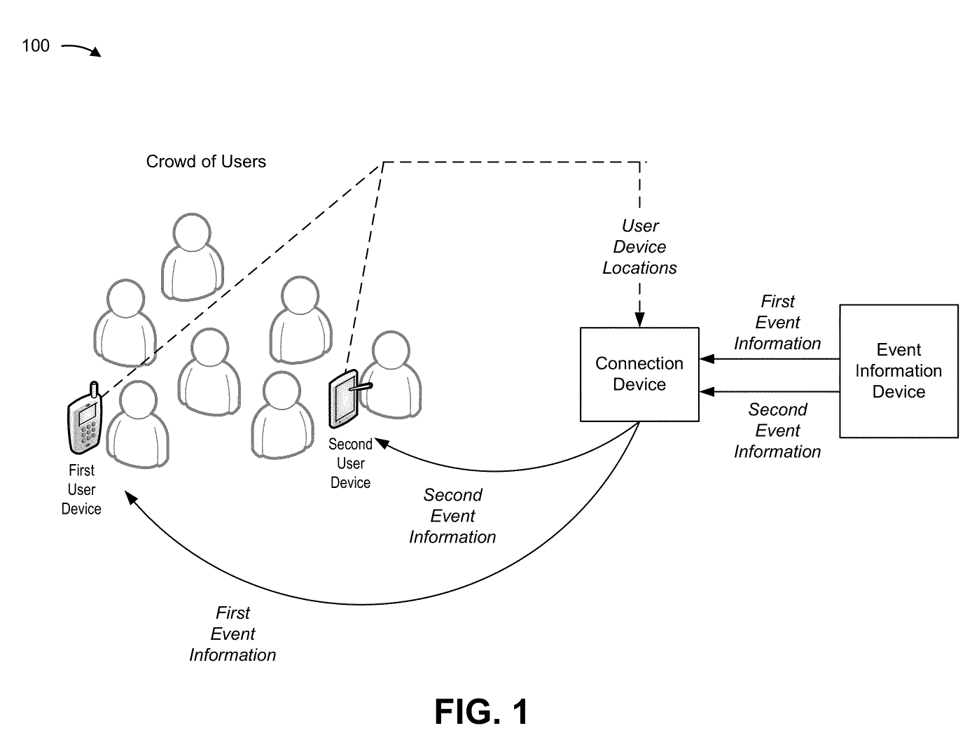

FIG. 1 is a diagram of an example implementation 100 described herein. As shown in FIG. 1, example implementation 100 may include a crowd of users, a first user device, a second user device, a connection device, and an event information device.

As shown in FIG. 1, a first user and a second user may be members of the crowd of users. For example, the crowd of users may be a crowd at a music concert. The first user may be associated with the first user device (e.g., a smartphone) and the second user may be associated with the second user device (e.g., a tablet computer). The connection device may determine a first user device location of the first user device and a second user device location of the second user device (e.g., via a global positioning system (“GPS”)). Using the first user device location and the second user device location, the connection device may determine the proximity of the first user device and the second user device. For example, the connection device may determine the locations of the user devices with respect to each other.

As further shown in FIG. 1, the connection device may receive first event information and second event information from an event information device. The first and second event information may include text, a picture, an animation, a video, or the like, to be displayed on a first display associated with the first user device and a second display associated with the second user device, respectively. The connection device may provide the first event information and the second event information to the first user device and the second user device, respectively, based on the proximity of the user devices to each other. For example, as the first user device and the second user device move closer to each other, the connection device may provide the first event information and the second event information based on the decreased proximity between the user devices (e.g., may provide new text, a new picture, a new animation, a new video, etc.). In this manner, the user devices may interact based on participation of the user devices in the event and the proximity of the user devices to one another.

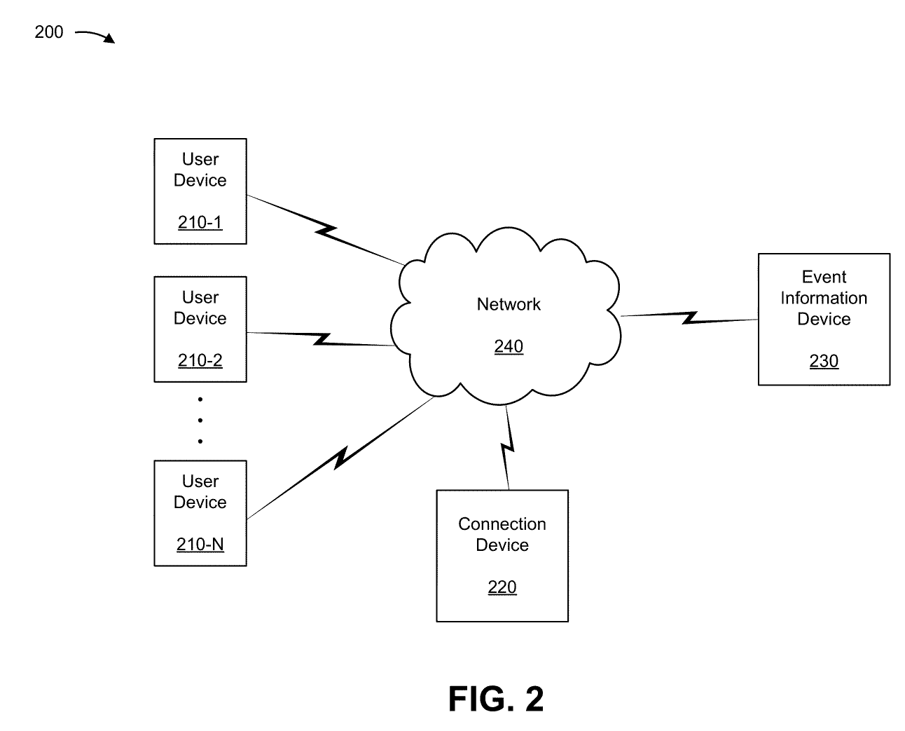

FIG. 2 is a diagram of an example environment 200 in which systems and/or methods described herein may be implemented. As shown in FIG. 2, environment 200 may include user devices 210-1, 210-2, . . . , 210-N (N≧1) (hereinafter referred to collectively as “user devices 210,” and individually as “user device 210”), connection device 220, event information device 230, and network 240. Devices of environment 200 may interconnect via wired connections, wireless connections, or a combination of wired and wireless connections.

User device 210 may include a device capable of receiving information associated with an event. For example, user device 210 may include a mobile phone (e.g., a smart phone, a radiotelephone, etc.), a computing device (e.g., a desktop computer, a laptop computer, a tablet computer, a handheld computer, etc.), or a similar device. In some implementations, user device 210 may include a display that outputs information from user device 210 and/or that allows a user to provide input to user device 210. Additionally, or alternatively, user device 210 may receive information from and/or transmit information to connection device 220 and/or event information device 230 (e.g., location information, event information, etc.).

Connection device 220 may include a device capable of providing information associated with an event to user devices 210. For example, connection device 220 may include a computing device (e.g., a desktop computer, a laptop computer, a tablet computer, a handheld computer, a server device, etc.) or a similar device. Connection device 220 may receive information from and/or transmit information to (e.g., event information) user devices 210 and/or event information device 230.

Event information device 230 may include a device capable of receiving, processing, storing, and/or providing information, such as information associated with an event. For example, event information device 230 may include a computing device (e.g., a desktop computer, a laptop computer, a tablet computer, a handheld computer, a server device, etc.) or a similar device. Event information device 230 may receive information from and/or transmit information to user devices 210 and/or connection device 220 (e.g., location information, event information, etc.).

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks. Additionally, or alternatively, network 240 may include a peer-to-peer network, a near field communication (“NFC”) network, or the like.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

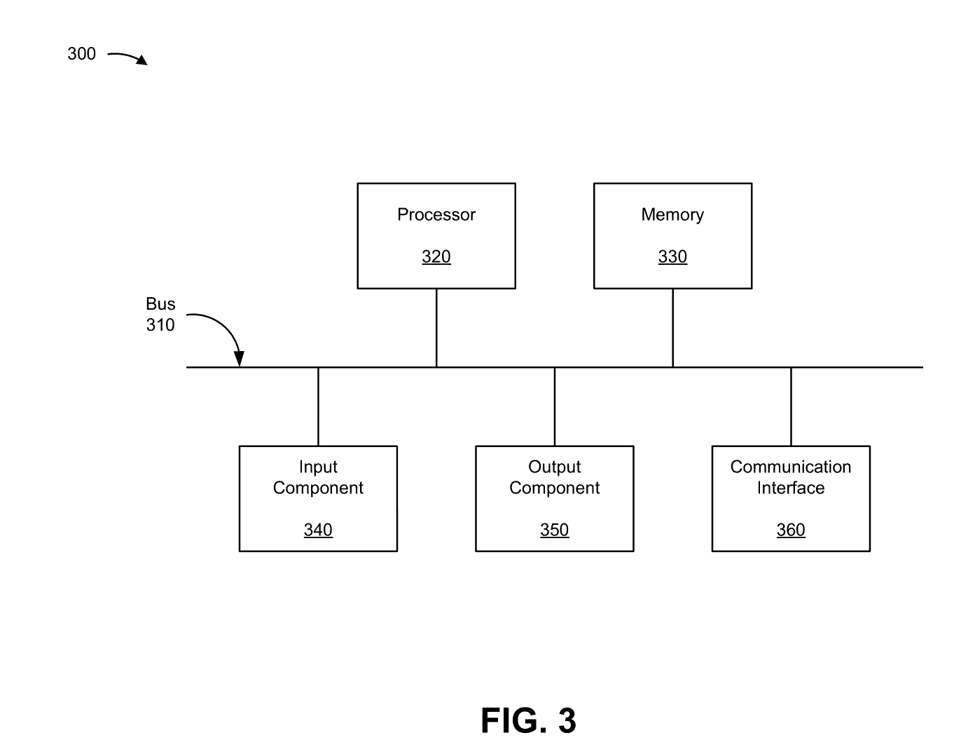

FIG. 3 is a diagram of example components of a device 300. Device 300 may correspond to user device 210, connection device 220, and/or event information device 230. Additionally, or alternatively, each of user device 210, connection device 220, and/or event information device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g. a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

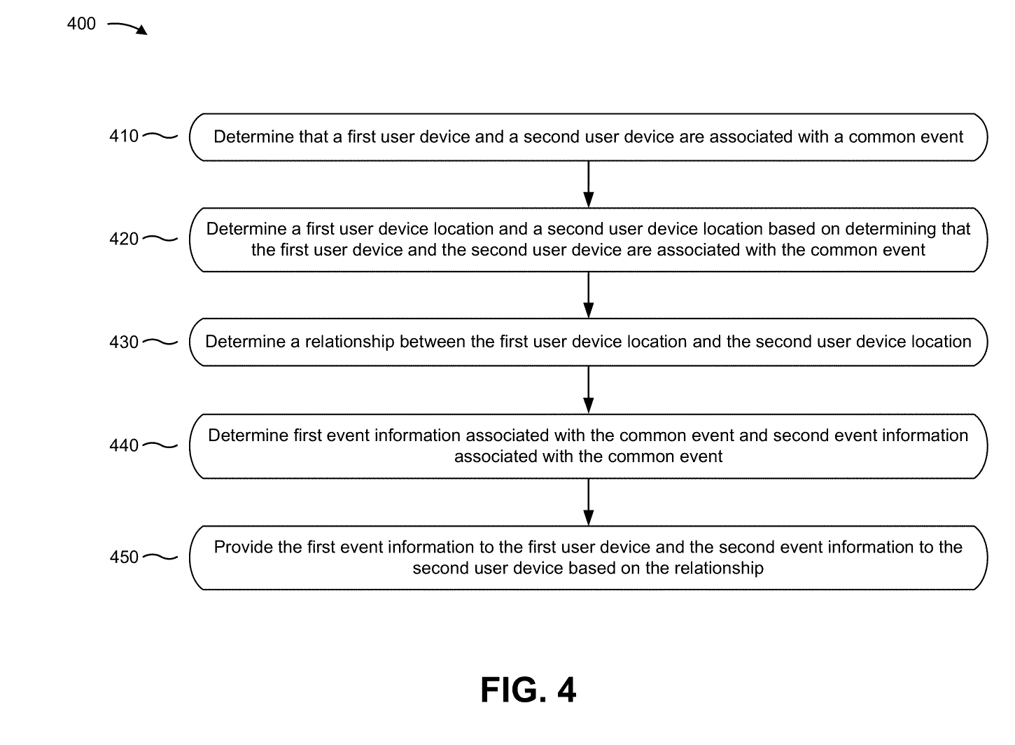

FIG. 4 is a flow chart of an example process 400 for providing event information to user devices based on a proximity of the user devices to one another. In some implementations, one or more process blocks of FIG. 4 may be performed by connection device 220. Additionally, or alternatively, one or more process blocks of FIG. 4 may be performed by another device or a group of devices separate from or including connection device 220, such as user device 210 and/or event information device 230.

As shown in FIG. 4, process 400 may include determining that a first user device and a second user device are associated with a common event (block 410). For example, connection device 220 may determine that first user device 210-1 and second user device 210-2 are associated with a common event (e.g., a concert, a sporting contest, etc.). In some implementations, connection device 220 may receive information from event information device 230 indicating that user devices 210 are associated with the event. For example, connection device 220 may receive information indicating that a first user and a second user associated with first user device 210-1 and second user device 210-2, respectively, have purchased tickets to the same sporting event, have indicated on a social network site that first user device 210-1 and second user device 210-2 are present at the event, or the like.

In some implementations, connection device 220 may determine that the first user device 210-1 and the second user device 210-2 are associated with the event based on the locations of user devices 210. For example, connection device 220 may detect a first user device location associated with first user device 210-1 and a second user device location associated with second user device 210-2. Connection device 220 may determine that the first user device location is near (e.g., within a threshold distance) the second user device location.

In some implementations, connection device 220 may determine that first user device 210-1 and second user device 210-2 are associated with the event based on user input. For example, a user associated with user device 210 may provide user input indicating that user device 210 is associated with the event. The user may provide the user input via a user interface, a touchscreen display, a keyboard, a keypad, or the like.

As further shown in FIG. 4, process 400 may include determining a first user device location and a second user device location based on determining that the first user device and the second user device are associated with the common event (block 420). For example, connection device 220 may determine that first user device 210-1 and second user device 210-2 are associated with the event (e.g., are present at the event, are in a crowd associated with the event, etc.). Based on determining that first user device 210-1 and second user devices 210-2 are associated with the event, connection device 220 may determine the first user device location associated with first user device 210-1 and the second user device location associated with second user device 210-2. As used herein, user device location may refer to a location of the first user device 210-1, a location of the second user device 210-2, and/or a location of other user devices 210.

In some implementations, connection device 220 may determine a user device location by use of a global positioning system (“GPS”). For example, first user device 210-1 may detect the first user device location, and second user device 210-2 may detect the second user device location, by use of location information determined from the GPS. Connection device 220 may receive a notification from user device 210 that identifies user device location (e.g., the location determined via GPS). Additionally, or alternatively, connection device 220 may detect the user device location by use of a device that emits an identifying signal, such as a transponder, a GPS-based object tag (e.g., a micro GPS device), or the like.

In some implementations, connection device 220 may determine the user device location by use of an indoor positioning system (“IPS”). The IPS may include a network of devices used to wirelessly locate user device 210 (e.g., via optical technologies, radio technologies, acoustic technologies, etc.) inside of a region (e.g., a building, a stadium, etc.). For example, the IPS may include several anchors (e.g., nodes with known positions) that actively locate tags (e.g., tags associated with user device 210) and/or provide information for user device 210 and/or connection device 220 to detect and/or determine the user device locations.

In some implementations, connection device 220 may detect the user device location by use of a cellular tower. For example, user device 210 may include a cellular telephone connected to a cellular telephone network (e.g., network 240) via the cellular tower (e.g., a base station, a base transceiver station (“BTS”), a mobile phone mast, etc.). Connection device 220 may detect the user device location by detecting a location of the particular cellular tower to which user device 210 is connected. Additionally, or alternatively, connection device 220 may use two or more cellular towers to determine the user device location by trilateration (e.g., by determining the position of user device 210 based on measuring the distance from the cellular tower to user device 210), triangulation (e.g., by determining the position of user device 210 based on angles from user device 210 to a known baseline), multilateration (e.g., by determining the position of user device 210 based on the measurement of the difference in distance between two or more cellular towers at known locations broadcasting signals at known times), or the like.

In some implementations, connection device 220 may determine the user device location by receiving user input from user device 210. For example, a user of user device 210 may provide the user device location by entering location information (e.g., an address, a longitude and a latitude, a GPS position, a seat identifier, a section identifier, a floor identifier, etc.) into user device 210 (e.g., via a user interface associated with user device 210). Connection device 220 may receive the user input from user device 210, and may determine the user device location based on the user input.

As further shown in FIG. 4, process 400 may include determining a relationship between the first user device location and the second user device location (block 430). For example, connection device 220 may determine the relationship between the first user device location and the second user device location by determining that first user device 210-1 is within a threshold proximity of second user device 210-2 (e.g., that first user device 210-1 is positioned a particular distance from second user device 210-2). For example, connection device 220 may determine the first user device location and the second user device location. Connection device 220 may determine that the first user device location is a particular distance (e.g., ten meters) from the second user device location.

In some implementations, connection device 220 may determine that first user device 210-1 and second user device 210-2 are within a threshold proximity by use of near field communication (“NFC”). For example, first user device 210-1 may establish a connection (e.g., a radio communication connection) with second user device 210-2 when placed within a threshold distance (e.g., a few centimeters) of second user device 210-2. Connection device 220 may determine the proximity between user devices 210 by determining that user devices 210 have established the connection. Additionally, or alternatively, connection device 220 may determine the proximity between user devices 210 by use of a ping test (e.g., by measuring a round-trip time for a message sent from first user device 210-1 to second user device 210-2 and back to first user device 210-1).

In some implementations, connection device 220 may determine the relationship between the first user device location and the second user device location based on a positional relationship between first user device 210-1 and second user device 210-2 (e.g., a location of first user device 210-1 with respect to second user device 210-2 and/or a location of second user device 210-2 with respect to first user device 210-1). For example, connection device 220 may determine that first user device 210-1 is located at a particular position with respect to second user device 210-2 (e.g., that first user device 210-1 is positioned higher than second user device 210-2, is positioned to the left of second user device 210-2, is positioned behind second user device 210-2, is positioned at a different elevation than second user device 210-2, etc.).

In some implementations, connection device 220 may determine the relationship by determining that first user device 210-1 can detect second user device 210-2. For example, first user device 210-1 may detect second user device 210-2 via a sensor, a camera, a microphone, or a similar device associated with first user device 210-1. In some implementations, connection device 220 may receive a notification from user device 210 indicating that user device 210 is detecting another user device 210.

As further shown in FIG. 4, process 400 may include determining first event information associated with the common event and second event information associated with the common event (block 440). For example, connection device 220 may receive first event information and second event information, associated with the event, from event information device 230. In some implementations, the event information may include text (e.g., a document), an image (e.g., a picture, a photograph, etc.), an animation, a video, an audio message (e.g., a song, a recorded conversation, etc.), or the like. In some implementations, the event information may be stored in a data structure associated with connection device 220 and/or event information device 230. As used herein, event information may refer to first event information, second event information, and/or other event information.

In some implementations, the event information may include information for display on user device 210. For example, the event may include a sporting event (e.g., a football game, a basketball game, etc.), and the event information may include information to be displayed at certain times during the event (e.g., a video to be played after a touchdown, an animation to be played during a free-throw attempt, a picture to be displayed during the national anthem, an advertisement to be played during a timeout, etc.).

In some implementations, the event information may include information received from user device 210. For example, connection device 220 may receive information from user devices 210 during the course of the event (e.g., pictures taken during the event, text messages written during the event, audio captured during the event, etc.). Connection device 220 may provide the information received from user device 210 (e.g., first and/or second event information) to another user device 210 associated with the event. For example, connection device 220 may provide information received from first user device 210-1 to second user device 210-2, and may provide information received from second user device 210-2 to first user device 210-1.

In some implementations, connection device 220 may combine the information received from user devices 210 (e.g., may combine pictures) based on the location of user devices 210. For example, connection device 220 may receive a first picture from first user device 210-1 associated with a first user device location. Connection device 220 may receive a second picture from second user device 210-2 associated with a second user device. Based on the first user device location and the second user device location, connection device 220 may combine the first picture and the second picture into a combined image (e.g., a collage, a panoramic, a three-dimensional representation, etc.).

In some implementations, the first event information may be different from the second event information. Connection device 220 may determine the event information based on the relationship of user devices 210 (e.g., a positional relationship, a size relationship, etc.), the locations of user devices 210, the direction of user devices 210, or the like. For example, connection device 220 may determine that first user device 210-1 is at a first user device location (e.g., a center of a crowd) and second user device 210-2 is at a second user device location (e.g., an edge of the crowd). Based on the user device locations, connection device 220 may determine first event information (e.g., a graphic effect that causes the first user device to display the color red) and second event information (e.g., a graphic effect that causes the second user device to display the color blue). In this manner, connection device 220 may determine event information based on the user device locations (e.g., user devices 210 toward the center of the crowd may display the color red, user devices 210 outside of the center of the crowd may display the color purple, user devices 210 at the edge of the crowd may display the color blue, etc.).

In some implementations, the event information may include an image, and connection device 220 may provide different portions of the image to different user devices 210 based on a positional relationship of user devices 210. For example, connection device 220 may receive an image (e.g., event information) from event information device 230. Connection device 220 may divide the image into two or more image portions (e.g., a first image portion, a second image portion, etc.). Connection device 220 may determine the positional relationship of user devices 210 (e.g., that the first user device 210-1 is to the left of user device 210-2, when viewed from a particular point). Based on the positional relationship of user devices 210, connection device 220 may provide the first image portion (e.g., first event information) to first user device 210-1 and the second image portion (e.g., second event information) to second user device 210-2. The first image portion may include a portion of the image located to the left of the second image portion, such that when the first image portion is displayed to the left of the second image portion the image portions combine to form the image. In this manner, the displays of user devices 210 may display the image portions to collectively display the entire image.

In some implementations, the event information may include a video, and connection device 220 may provide different portions of the video to different user devices 210 based on the user device locations. Additionally, or alternatively, the event information may include information that informs user devices 210 when to play the video. For example, connection device 220 may provide the video (e.g., an animation of a wave) to user devices 210 (e.g., located in a stadium crowd). Connection device 220 may provide first event information (e.g., information including when to play the video) to first user device 210-1, second event information to second device 210-2, third event information to third user device 210-3, and so forth. The event information may indicate that user devices 210 near a first location (e.g., a first section of the stadium crowd) are to begin to play the video first, user devices 210 near a second location (e.g., a second section of the stadium crowd) are to begin to play the video second, user devices 210 near a third location (e.g., a third section of the stadium crowd) are to begin to play the video third, and so forth. In this manner, a video of a wave on the displays of user devices 210 may proceed from one end of the stadium to the other.

In some implementations, the event information may include a song, and connection device 220 may provide different portions of the song (e.g., a quantity of the song, a part of the song played by a particular instrument, etc.) to different user devices 210 based on the user device locations. For example, connection device 220 may provide a first portion of the song to first user device 210-1 and a second portion of the song to user device 210-2 based on the positional relationship between first user device 210-1 and second user device 210-2. In some implementations, user devices 210 near a first location (e.g., a first region of a crowd) may receive the first portion of the song (e.g., a portion corresponding to a drum track of the song) and user devices 210 near a second location (e.g., a second region of the crowd) may receive the second portion of the song (e.g., a portion corresponding to a guitar track of the song) based on the locations of user devices 210. Connection device 220 may provide information identifying when user device 210 is to play the portion of the song. In this manner, user devices 210 may play the portions of the song to collectively play the entire song.

In some implementations, the event information may include a graphic effect (e.g., an animation, a video, a flashing light, etc.) that displays differently (e.g., at different rates, at different times, in different colors, etc.) depending on the positional relationship between user devices 210. Additionally, or alternatively, the first and/or the second event information may be displayed depending on an interaction (e.g., a motion, a user selection, etc.) of user devices 210.

In some implementations, connection device 220 may determine the event information based on a device type associated with first user device 210-1 and/or second user device 210-2. For example, first user device 210-1 may be of a first device type (e.g., a smartphone) and second user device 210-2 may be of a second device type (e.g., a tablet computer). The event information may include an image, and connection device 220 may determine the portion of the image to provide to first user device 210-1 and second user device 210-2 based on the first device type and the second device type. Connection device 220 may determine that the first event information is to include a smaller portion of an image than the second event information based on first user device 210-1 (e.g., the smartphone) having a smaller display than second user device 210-2 (e.g., the tablet computer). Additionally, or alternatively, connection device 220 may determine the first event information and/or the second event information based on one or more attributes of the first and/or the second user device 210 (e.g., a display type, a display resolution, a storage capacity, a type of software installed on user device 210, an amount of network bandwidth available to user device 210, etc.).

As further shown in FIG. 4, process 400 may include providing the first event information to the first user device and the second event information to the second user device based on the relationship (block 450). For example, connection device 220 may provide the first event information to first user device 210-1, and may provide the second event information to second user device 210-2, based on the user device locations (e.g., based on the distance between first user device 210-1 and second user devices 210-2).

In some implementations, connection device 220 may provide the event information by sending a file (e.g., a block of event information for use in a computer program) to user device 210. For example, connection device 220 may send a first file to first user device 210-1 and a second file to second user device 210-2. In some implementations, first user device 210-1 and/or second user device 210-2 may store the event information (e.g., in a data structure associated with first user device 210-1 and/or second user device 210-2). Additionally, or alternatively, first user device 210-1 and/or second user device 210-2 may display the event information on a display (e.g., a user interface, a screen, a touchscreen display, etc.) associated with first user device 210-1 and/or second user device 210-2.

In some implementations, connection device 220 may provide the event information by streaming the event information via a network (e.g., network 240). For example, the event information may include a media presentation (e.g., a song, a video, etc.), and connection device 220 may stream the media presentation to user devices 210. Additionally, or alternatively, connection device 220 may provide the event information via a short message service (“SMS”) text, an email to an email account associated with a user of user device 210, or the like.

In some implementations, connection device 220 may provide the first event information and/or the second event information to user devices 210 via radio communications between user devices 210 (e.g., via near field communication). For example, connection device 220 may provide first and second event information to one of user devices 210 (e.g., first user device 210-1), which may provide the second event information to another of user devices 210 (e.g., the second user device 210-2) via near field communication. Additionally, or alternatively, connection device 220 may provide the first and the second event information via a peer-to-peer network (e.g., a network between first user device 210-1 and second user device 210-2).

In some implementations, connection device 220 may provide the event information based on one or more user preferences. For example, user device 210 may receive one or more user preferences via user input. Connection device 220 may receive the one or more user preferences from user device 210. In some implementations, the user preferences may indicate a type (e.g., a class, a group, etc.) of event information that connection device 220 is to provide to user device 210. For example, the user information may include a preference by a user of user device 210 to receive a type of event information (e.g., a video, a song, etc.) associated with a type of event (e.g., a concert, a sporting event, etc.).

While a series of blocks has been described with regard to FIG. 4, the blocks and/or the order of the blocks may be modified in some implementations. Additionally, or alternatively, non-dependent blocks may be performed in parallel. Furthermore, one or more blocks may be omitted in some implementations.

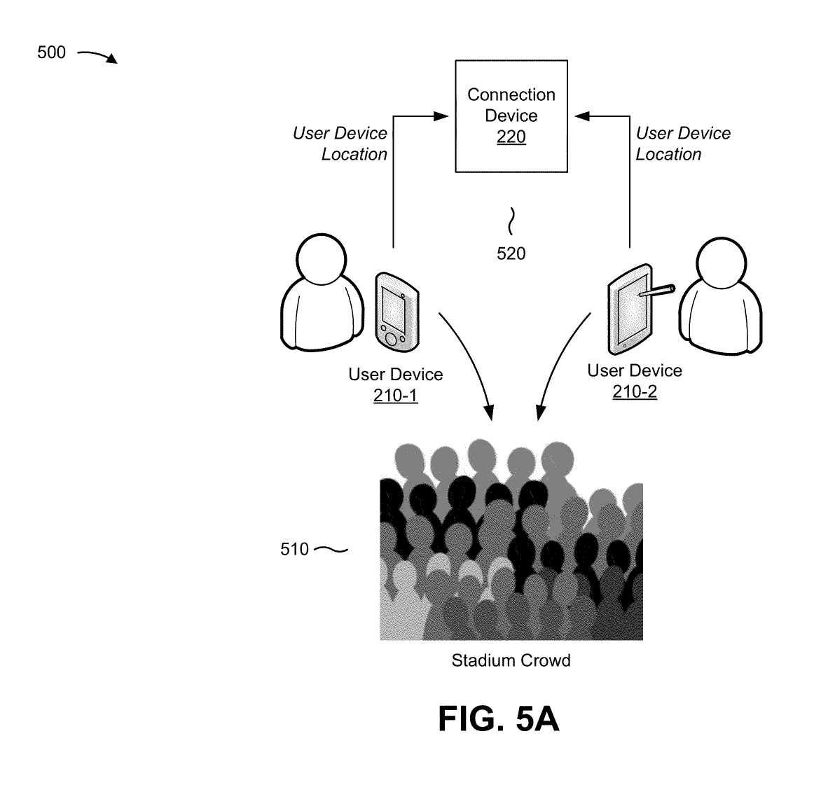

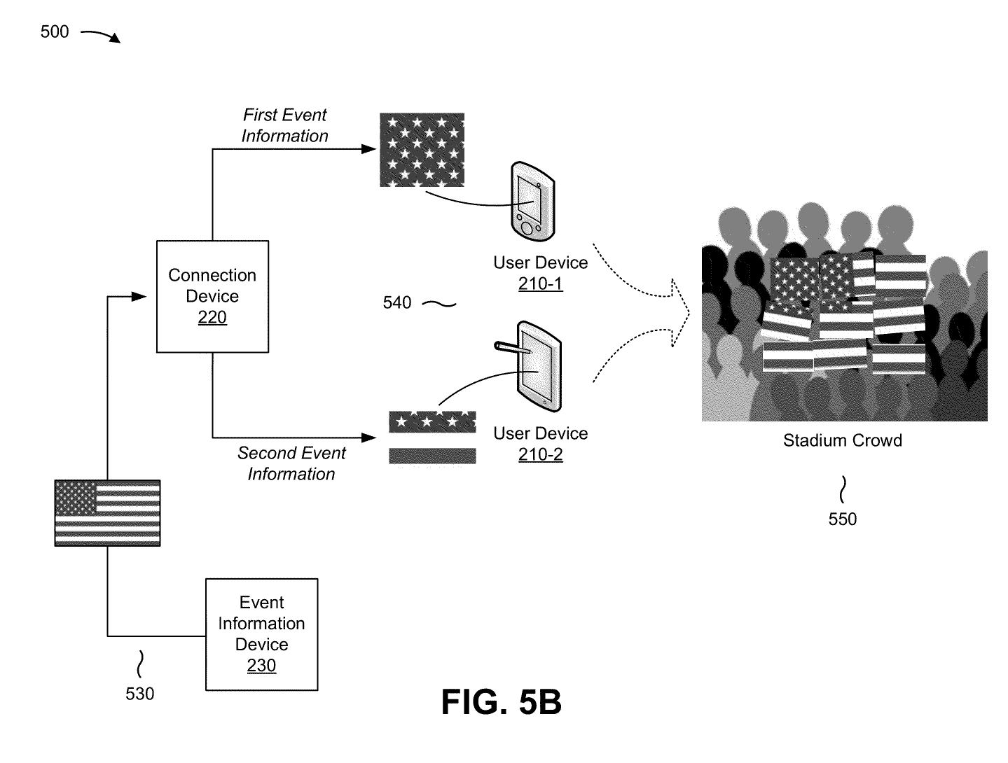

FIGS. 5A and 5B are diagrams of an example implementation 500 relating to process 400 shown in FIG. 4. In example implementation 500, connection device 220 may provide portions of an image for display on multiple user devices 210 in a stadium crowd.

As shown in FIG. 5A, and by reference number 510, a first user device 210-1 (e.g., a smartphone) and a second user device 210-2 (e.g., a tablet computer) may be associated with a first user and a second user, respectively. The first and second users may be members of a stadium crowd at a football game (e.g., an event). The user devices 210 may determine first and second user device locations via GPS. Connection device 220 may determine the first and the second user device locations by receiving a first notification and a second notification from the first and the second user devices 210 (e.g., the first and second notifications including location information), respectively, as shown by reference number 520.

As shown in FIG. 5B, and by reference number 530, connection device 220 may receive event information from event information device 230. The event information may include an image of an American flag. Connection device 220 may receive the event information at the start of the national anthem.

As shown by reference number 540, connection device 220 may provide portions of the image of the American flag to user devices 210. The first user device 210-1 may receive a first portion of the image (e.g., first event information) and the second user device 210-2 may receive a second portion of the image (e.g., second event information). Connection device 220 may determine and/or provide the first and the second image portions to the first and the second user devices 210 based on their location with respect to one another (e.g., based on the first user device 210-1 being located higher than the second user device 210-2, based on the first user device 210-1 being located to the left of the second user device 210-2, etc.).

As shown by reference number 550, the first and the second users may hold the first and the second user devices 210 for others in the stadium crowd to view. The first and second users may be joined with other nearby users (e.g., users of a third user device 210, a fourth user device 210, etc.) that have received event information (e.g., a third portion of the image, a fourth portion of the image, etc.) from connection device 220. User devices 210 may display the respective portions of the images on respective displays (e.g., screens, touchscreen displays, user interfaces, etc.) associated with user devices 210. In this manner, a collective image may be shown using multiple user devices 210.

As indicated above, FIGS. 5A and 5B are provided merely as an example. Other examples are possible and may differ from what was described with regard to FIGS. 5A and 5B.

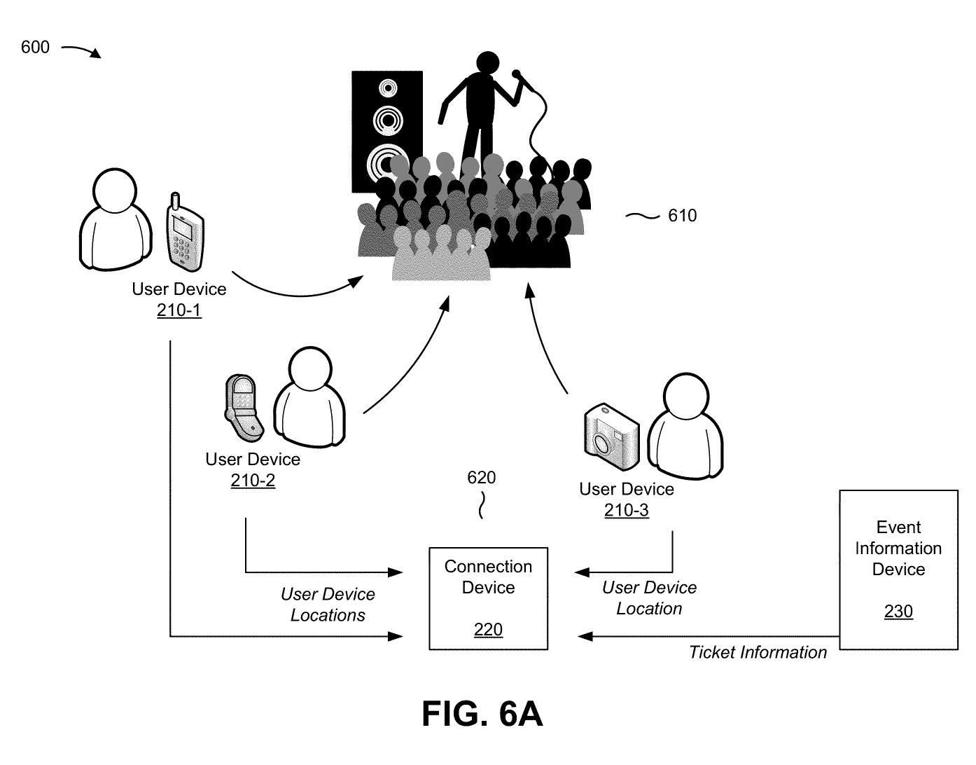

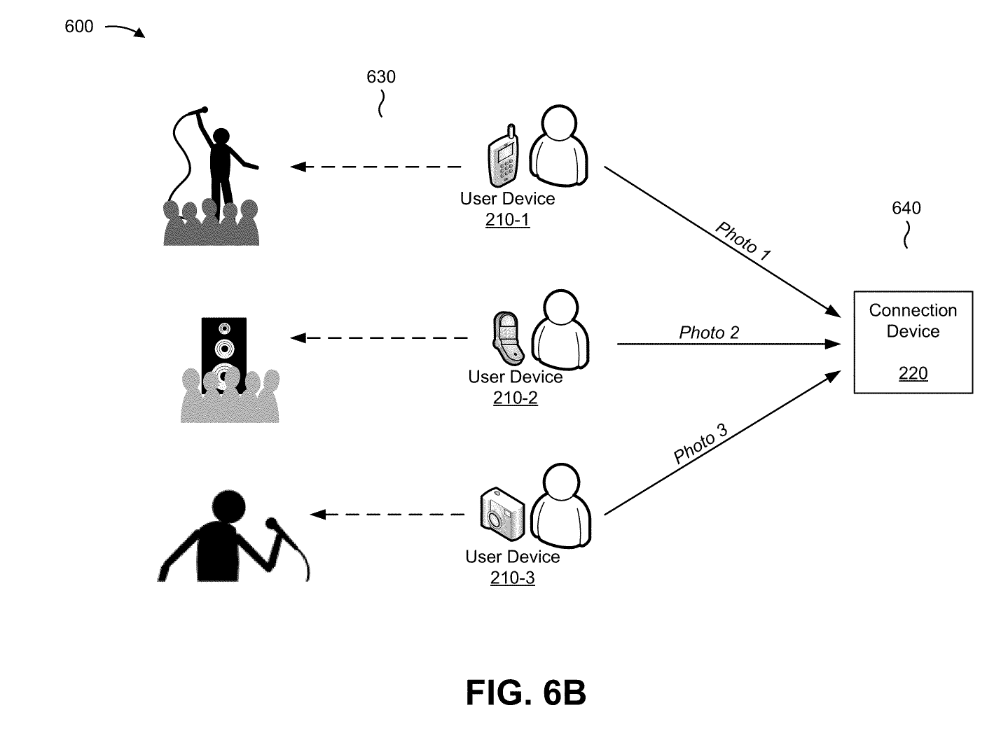

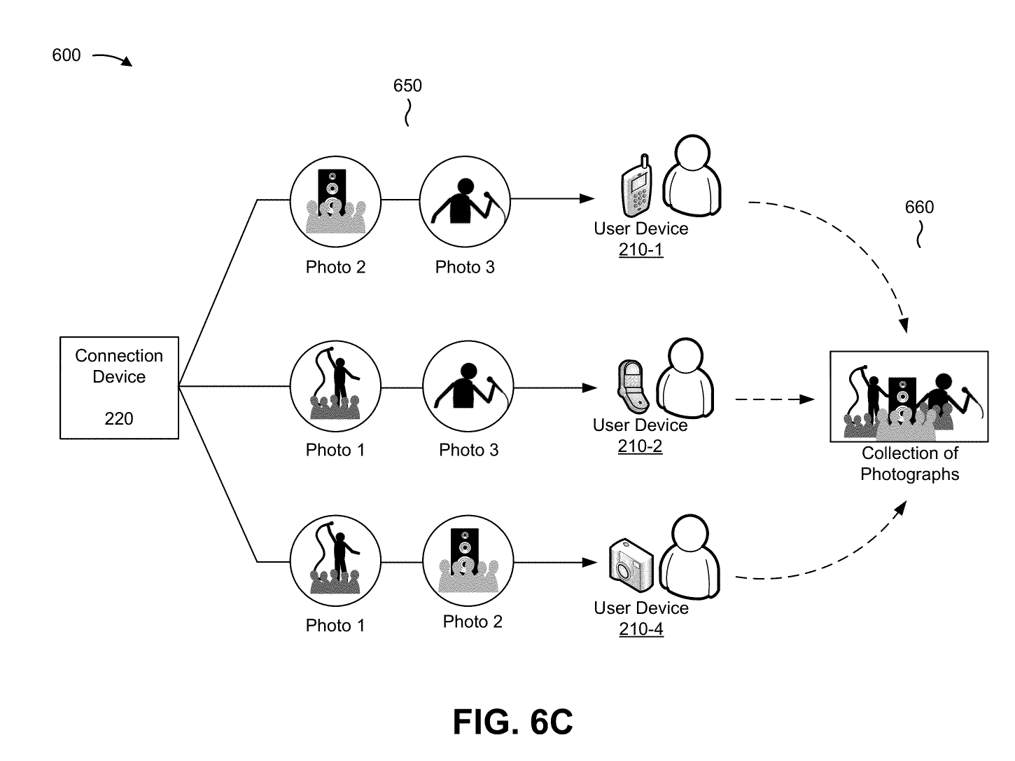

FIGS. 6A-6C are diagrams of another example implementation 600 relating to process 400 shown in FIG. 4. In example implementation 600, assume that connection device 220 receives photographs of a concert taken by user devices 210 at the concert. Connection device 220 may provide the photographs to user devices 210, and may assemble a collection of photographs based on the locations of user devices 210.

As shown in FIG. 6A, and by reference number 610, first user device 210-1 (e.g., a smartphone), second user device 210-2 (e.g., a cellular phone), and third user device 210-3 (e.g., a camera) may be associated with a first user, a second user, and a third user, respectively. Connection device 220 may determine that the users are present at the concert based on ticket information received from event information device 230 (e.g., based on information that the users purchased tickets to the concert), as shown by reference number 620. Connection device 220 may determine a first user device location associated with first user device 210-1, a second user device location associated with second user device 210-2, and a third user device location associated with third user device 210-3 via a GPS (e.g., based on receiving GPS information from user devices 210).

As shown in FIG. 6B, and by reference number 630, user devices 210 may take photographs of people and/or objects at the concert. User devices 210 may use a camera application to take the photographs. As shown by reference number 640, connection device 220 may receive the photographs (e.g., first event information, second event information, and third event information) from user devices 210 (e.g., “Photo 1” from user device 210-1, “Photo 2” from user device 210-2, and “Photo 3” from user device 210-3) via a network. For example, the camera application may determine that user device 210 has taken a photograph and may provide the photograph to connection device 220.

As shown in FIG. 6C, and by reference number 650, connection device 220 may provide the photographs to user devices 210 (e.g., the photographs taken by surrounding user devices 210) based on the user device locations. For example, user device 210-1 may receive the photographs (e.g., first event information) taken by user devices 210-2 and 210-3 (e.g., “Photo 2” and “Photo 3”). User device 210-2 may receive the photographs (e.g., second event information) taken by user device 210-1 and 210-3 (e.g., “Photo 1” and “Photo 3”). User device 210-3 may receive the photographs (e.g., third event information) taken by user device 210-1 and 210-2 (e.g., “Photo 1” and “Photo 2”). In some implementations, a user of user device 210 may provide user input (e.g., via a user interface associated with user device 210) that identifies a user preference for a type of photograph to receive (e.g., the user may indicate a preference to only receive photographs of a performer, photographs that include images of the user, etc.). Connection device 220 may receive the user input and may provide the photographs to user device 210 based on the user input (e.g., based on the user preference).

As shown by reference number 660, connection device 220 may combine the photographs into a collection of photographs (e.g., a collage, a photomontage, etc.). Using the user device locations at the time of each photograph, connection device 220 may combine the photographs (e.g., may place photographs in the collection of photographs with respect to their locations at the concert). Connection device 220 may provide the collection of photographs to user devices 210 via a network (e.g., by providing the collection of photographs on a website accessible to user devices 210).

As indicated above, FIGS. 6A-6C are provided merely as an example. Other examples are possible and may differ from what was described with regard to FIGS. 6A-6C.

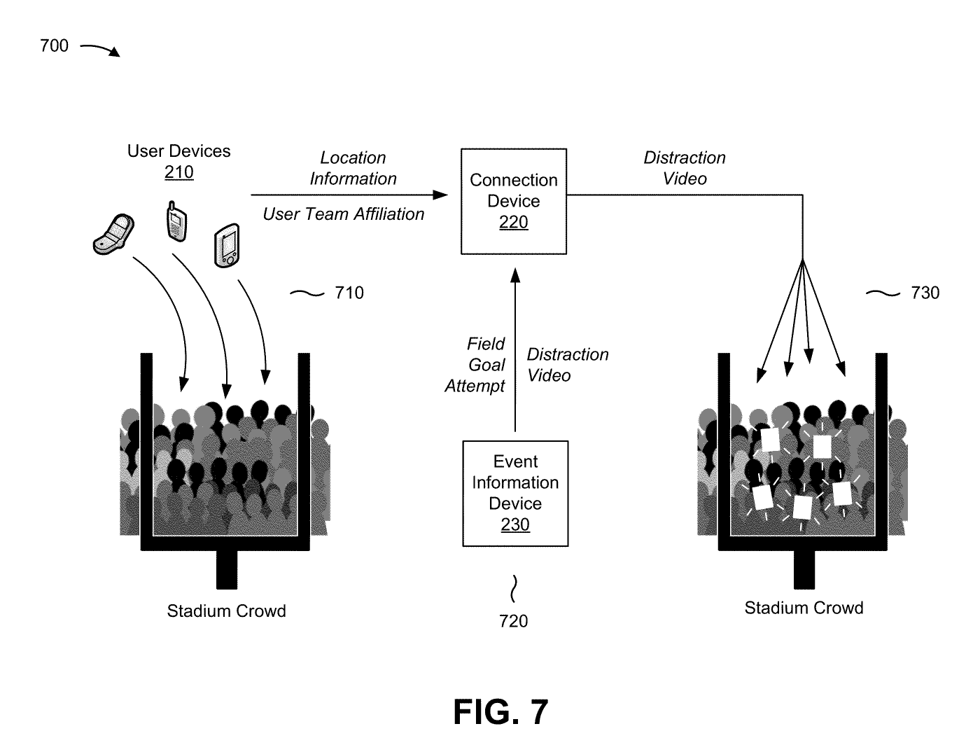

FIG. 7 is a diagram of yet another example implementation 700 relating to process 400 shown in FIG. 4. In example implementation 700, assume that user devices 210 in a stadium crowd behind a goal post receive animations to display during a field goal attempt by an opposing team.

As shown by reference number 710, user devices 210 may be associated with users in a stadium crowd at a football game. The users may be seated in the stadium crowd behind a goal post. Connection device 220 may detect the user device locations associated with user devices 210 via GPS (e.g., by receiving GPS information from user devices 210). The users may provide user input (e.g., via user interfaces associated with user devices 210) indicating a user team affiliation (e.g., an indication of which of the two football teams the user and/or user device 210 has an affiliation). Connection device 220 may receive the user team affiliation (e.g., the user input) from user devices 210.

As shown by reference number 720, connection device 220 may receive event information from event information device 230. The event information may include an indication that a kicking football team is about to attempt a field goal. The event information may also include a distraction video (e.g., a video to be played during the field goal attempt intended to distract the kicking football team).

As shown by reference number 730, connection device 220 may provide the distraction video to a portion of user devices 210 based on the user device locations (e.g., to only user devices 210 located behind the field goal) and based on the user team affiliation (e.g., to only the portion of user devices 210 affiliated with a non-kicking football team). User devices 210 may display the distraction video during the field goal attempt. Based on the proximity between the user devices 210, connection device 220 may cause the distraction video to play at different times (e.g., to flash at different times from nearby user devices 210).

As indicated above, FIG. 7 is provided merely as an example. Other examples are possible and may differ from what was described with regard to FIG. 7.

Implementations described herein may allow user devices to interact based on their participation in an event and the proximity of user devices to one another.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more times, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
determine that a first user device and a second user device are associated with an event;
determine a first user device location and a second user device location,
the first user device location indicating a location of the first user device,
the second user device location indicating a location of the second user device;
determine a relationship between the first user device location and the second user device location;
determine first event information and second event information based on the relationship,
the first event information and the second event information being associated with the event,
the first event information being different from the second event information;
provide the first event information to the first user device; and
provide the second event information to the second user device.

2. The device of claim 1, where the one or more processors, when determining the first event information and the second event information, are further to:
determine a first portion of an image and a second portion of the image; and
where the one or more processors, when providing the first event information and the second event information, are further to:
provide the first portion of the image to the first user device and the second portion of the image to the second user device based on the relationship between the first user device location and the second user device location.

3. The device of claim 1, where the first event information or the second event information includes at least one of:
a video associated with the event;
an image associated with the event;
a song associated with the event; or
text associated with the event.

4. The device of claim 1, where the one or more processors, when determining the relationship between the first user device location and the second user device location, are further to:
determine the relationship based on at least one of:
a global positioning system location associated with the first user device or the second user device;
a peer-to-peer network connection between the first user device and the second user device; or
a near field communication link between the first user device and the second user device.

5. The device of claim 1, where the one or more processors, when determining the first event information and the second event information, are further to:
determine the first event information and the second event information based on at least one of:
a device type associated with the first user device or the second user device;
a display resolution associated with the first user device or the second user device;
an amount of storage capacity associated with the first user device or the second user device; or
an amount of network bandwidth associated with the first user device or the second user device.

6. The device of claim 1, where the first event information indicates a time at which the first event information is to be displayed by the first user device; and
where the second event information indicates a time at which the second event information is to be displayed by the second user device.

7. The device of claim 1, where the one or more processors, when determining the first event information and the second event information, are further to:
receive a first image from the first user device;
receive a second image from the second user device;
generate a combined image based on the relationship between the first user device location and the second user device location;
where the one or more processors, when providing the first event information, are further to:
provide the combined image to the first user device; and
where the one or more processors, when providing the second event information, are further to:
provide the combined image to the second user device.

8. A computer-readable medium storing instructions, the instructions comprising:
one or more instructions that, when executed by a processor, cause the processor to:
determine that a first user device and a second user device are associated with a common event;
determine a relationship between a first location, associated with the first user device, and a second location associated with the second user device;
determine first event information and second event information based on the relationship between the first location and the second location,
the first event information and the second event information being associated with the event,
the first event information being different from the second event information; and
provide the first event information to the first user device and the second event information to the second user device.

9. The computer-readable medium of claim 8, where the one or more instructions, that cause the processor to determine the first event information and the second event information, further cause the processor to:
determine a first portion of an image and a second portion of the image; and
where the one or more instructions, that cause the processor to provide the first event information and the second event information, further cause the processor to:
provide the first portion of the image to the first user device and the second portion of the image to the second user device based on the relationship between the first location and the second location.

10. The computer-readable medium of claim 8, where the first event information or the second event information includes at least one of:
a video associated with the event;
an image associated with the event;
a song associated with the event; or
text associated with the event.

11. The computer-readable medium of claim 8, where the one or more instructions, that cause the processor to determine the relationship between the first location and the second location, further cause the processor to:
determine the relationship based on at least one of:
a global positioning system location associated with the first user device or the second user device;
a peer-to-peer network connection between the first user device and the second user device; or
a near field communication link between the first user device and the second user device.

12. The computer-readable medium of claim 8, where the one or more instructions, that cause the processor to determine the first event information and the second event information, further cause the processor to:
determine the first event information and the second event information based on at least on of:
a device type associated with the first user device or the second user device;
a display resolution associated with the first user device or the second user device;
an amount of storage capacity associated with the first user device or the second user device; or
an amount of network bandwidth associated with the first user device or the second user device.

13. The computer-readable medium of claim 8, where the one or more instructions, that cause the processor to determine the first event information and the second event information, further cause the processor to:
determine a first portion of a video and a second portion of the video,
the first event information indicating a time at which the first portion of the video is to be displayed by the first user device,
the second event information indicating a tine at which the second portion of the video is to be displayed by the second user device; and
where the one or more instructions, that cause the processor to provide the first event information and the second event information, further cause the processor to:
provide the first portion of the video to the first user device and the second portion of the video to the second user device based on the relationship between the first location and the second location.

14. The computer-readable medium of claim 8, where the one or more instructions, that cause the processor to determine the first event information and the second event information, further cause the processor to:
receive a first image from the first user device;
receive a second image from the second user device;
generate a combined image based on the relationship between the first location and the second location; and
where the one or more instructions, that cause the processor to provide the first event information and the second event information, further cause the processor to:
provide the combined image to the first user device and the second user device.

15. A method, comprising:
determining, by a device, a first user device location associated with a first user device;
determining, by the device, a second user device location associated with a second user device;
determining, by the device, a positional relationship between the first user device location and the second user device location;
determining, by the device, a first portion of event information to be provided to the first user device based on the positional relationship;
determining, by the device, a second portion of the event information to be provided to the second user device based on the positional relationship;
providing, by the device, the first portion of the event information to the first user device; and
providing, by the device, the second portion of the event information to the second user device.

16. The method of claim 15, where determining the first portion of the event information and the second portion of the event information further comprises:
determining a first portion of an image and a second portion of the image; and
where providing the first portion of the event information and the second portion of the event information further comprises:
providing the first portion of the image to the first user device and the second portion of the image to the second user device based on the positional relationship between the first user device location and the second user device location.

17. The method of claim 15, where determining the positional relationship between the first user device location and the second user device location further comprises:
determining the positional relationship based on at least one of:
a global positioning system location associated with the first user device or the second user device;
a peer-to-peer network connection between the first user device and the second user device; or
a near field communication link between the first user device and the second user device.

18. The method of claim 15, where determining the first portion of event information and the second portion of event information further comprises:
determining the first portion of the event information and the second portion of the event information based on at least one of:
a device type associated with the first user device or the second user device;
a display resolution associated with the first user device or the second user device;
an amount of storage capacity associated with the first user device or the second user device; or
an amount of network bandwidth associated with the first user device or the second user device.

19. The method of claim 15, where determining the first portion of the event information and the second portion of the event information further comprises:
determining a first portion of a song and a second portion of the song; and
where providing the first portion of the event information and the second portion of the event information further comprises:
providing the first portion of the song to the first user device and the second portion of the song to the second user device based on the positional relationship between the first user device location and the second user device location.

20. The method of claim 15, where determining the first portion of event information and the second portion of event information further comprises:
receiving a first image from the first user device;
receiving a second image from the second user device; and
generating a combined image based on the positional relationship between the first user device location and the second user device location;
where providing the first portion of event information further comprises:
providing the combined image to the first user device; and
where providing the second portion of event information further comprises:
providing the combined image to the second user device.
